(19) United States
(12) Patent Application Publication
(10) Pub. No.: US 2003/0178509 A1
(43) Pub. Date: Sep. 25, 2003

(54) Fuel injector with flux washer

(75) Inventor: David L. Porter, Westland, MI (US)

Correspondence Address: BRINKS HOFER GILSON & LIONE, P.O. BOX 10395, CHICAGO, IL, 60611, US

(73) Assignee: Visteon Global Technologies, Inc.

(21) Appl. No.: 10/101,902

(22) Filed: Mar. 19, 2002

(51) Int. Cl. B05B 1/30

(52) U.S. Cl. 239/585.1

(57) ABSTRACT

A fuel injector assembly includes a valve to selectively prevent fuel from flowing therethrough. An armature is fixedly mounted onto the valve, and a solenoid is adapted to generate a magnetic flux within the fuel injector to provide a magnetic force on the armature. A flux washer is disposed between the solenoid and the armature and provides a path for the magnetic flux.

### TECHNICAL FIELD

The present invention generally relates a fuel injector. Specifically, the present invention relates to a fuel injector having a flux washer adapted to provide a flux path to an armature of the fuel injector.

### BACKGROUND

Fuel injectors within an automobile typically include a valve to selectively stop the flow of fuel therethrough. A prior art fuel injector is shown in FIG. 1 and is designated with the reference number 10. The fuel injector 10 includes a valve 12 that mounted to move between an open position and a closed position. The valve 12 is biased to a closed position by a spring 14 and includes an armature 16. A solenoid 18 generates a magnetic flux that acts upon the armature 16 of the valve 12 to move the valve 12 into the open position. When the solenoid 18 is no longer energized, the force of the spring 14 closes the valve 12 once again.

As shown in FIG. 1, a path 20 of the magnetic flux passes axially through an outer casing 22 and radially through a valve body 24 to the armature 16. The flux then passes from the armature 16 axially to an inlet tube 26. The flux causes an axial magnetic attraction between the armature 16 and the inlet tube 26 that moves the valve 12 to an open position. In order to allow the armature 16 to move back and forth within the injector 10, there is an air gap between the armature 16 and a valve body 24 of the fuel injector 10. The flux passing across this air gap causes a radial magnetic attraction between the armature 16 and the valve body 24. The armature 16 remains centered, because the flux is acting all around the armature 360 degrees, however, the magnetic flux traveling across the air gap is wasted magnetic energy.

Fuel injectors have been developed with an armature that is large enough to extend out to the outer casing 12. However, problems with keeping the armature square within the valve body make that design impractical. Additionally, there is still wasted magnetic energy being lost radially around the armature. Therefore, there is a need for an improved fuel injector with a more efficient magnetic flux path.

### BRIEF DESCRIPTION OF THE DRAWINGS

FIG. 1 is a sectional view of a prior art fuel injector;

FIG. 2 is a sectional view of a fuel injector of the preferred embodiment;

FIG. 3 is an enlarged portion of FIG. 2 as shown by the circle labeled 3 shown in FIG. 2;

FIG. 4 is an enlarged view similar to FIG. 3, showing an alternative embodiment; and

FIG. 5 is an enlarged portion of FIG. 2 as shown by the circle labeled 5 shown in FIG. 2.

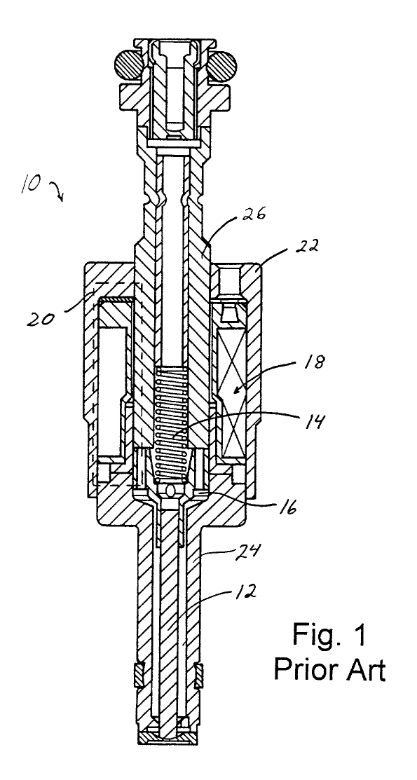

### DETAILED DESCRIPTION OF THE PREFRRED EMBODIMENT

The following description of the preferred embodiment of the invention is not intended to limit the scope of the invention to this preferred embodiment, but rather to enable any person skilled in the art to make and use the invention.

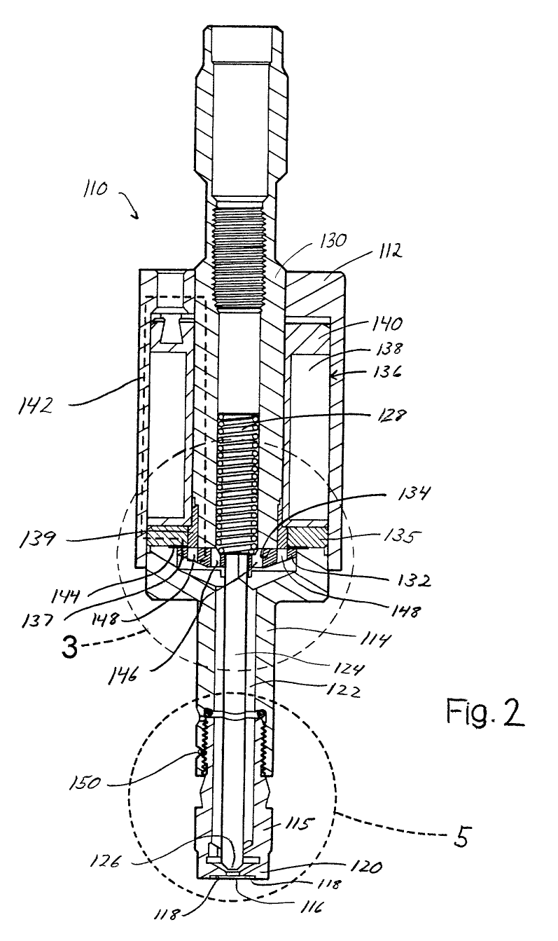

Referring to FIG. 2, a fuel injector of the present invention is shown generally at 110. The fuel injector 110 includes an outer casing 112 having a valve body 114 extending therefrom. The valve body 114 includes a tip portion 115 having a nozzle plate 116 with a plurality of orifice holes 118 extending therethrough. The nozzle plate 116 is mounted onto a seat 120 located at the end of the tip portion 115. The valve body 114 includes a fuel flow passage 122 that is adapted to transfer fuel to the nozzle plate 116. Fuel flows through the fuel flow passage 122 to the nozzle plate 116 and is injected into a cylinder of an engine.

The fuel injector 110 includes a valve 124 that selectively prevents fuel from flowing through the fuel flow passage 122. The valve 124 has a rounded end 126 that is adapted to engage the seat 120 to seal the fuel flow passage 122 and prevent fuel from flowing through the nozzle plate 116. The valve 124 is biased to a closed position by a spring 128 housed within an inlet tube 130. The valve 124 includes an armature 132 fixedly mounted to an end opposite the rounded end 126. When the valve 124 is in the closed position, there is an air gap between an end surface 134 of the inlet tube 130 and the armature 132.

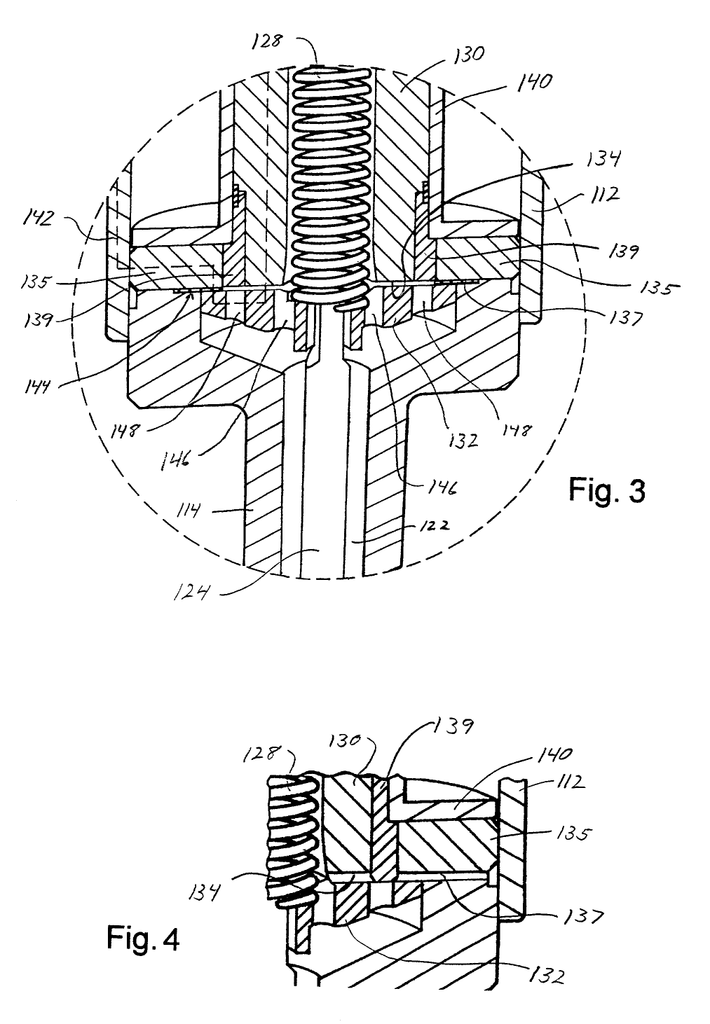

Referring to FIG. 3, a flux washer 135 is positioned within the outer casing 112 adjacent the end of the inlet tube 130. The flux washer 135 extends annularly around the fuel injector 110 and provides a magnetic path between the outer casing 112 and the inlet tube 130. A radial outer diameter of the flux washer 135 contacts the outer casing 112 and an axially-facing bottom surface 137 of the flux washer 135 is aligned with the end surface 134 of the inlet tube 130. The flux washer 135 extends radially inward such that the bottom surface 137 of the flux washer 135 overlaps the armature 132. The fuel injector includes a non-magnetic shield 139 positioned between the flux washer 135 and the inlet tube 130 adjacent the end of the inlet tube. The flux washer 135 is preferably made from a ferrous material, although the flux washer 135 can be made from any material that will conduct a magnetic flux therethrough. During manufacturing, in order to provide flatness and alignment, the flux washer 135, the shield 139, and the inlet tube 130 are preferably welded together and the bottom surface 137 of the flux washer 135 and the end surface 134 of the inlet tube 130 are simultaneously ground.

A solenoid 136 causes the valve 124 to move between the closed position, where there is a gap between the armature 132 and both the end surface 134 of the inlet tube 130 and the bottom surface 137 of the flux washer 135, and an open position where the armature 132 contacts both the end surface 134 of the inlet tube 130 and the bottom surface 137 of the flux washer 135, as shown in FIG. 2. The solenoid 136 includes a coil 138 mounted onto a bobbin 140 and extending around the inlet tube 130. The outer casing 112 of the fuel injector encloses the coil 138. When the coil 138 of the solenoid 136 is energized, a magnetic flux is generated.

A path 142 of the magnetic flux travels around the coil 138 through the outer casing 112, radially across the flux washer 135, axially downward into the armature 132, radially inward across the armature 132, and axially upward into the inlet tube 130. Preferably, the valve body 114 is made from a non-magnetic material to prevent the magnetic flux from being diverted into the valve body 114 and entering the armature 132 along the sides.

The magnetic flux causes a magnetic attraction between the end surface 134 of the inlet tube 130 and the armature 132 that provides an axial force which pulls the valve 124 against the force of the spring 128 and causes the valve 124 to move axially upward until the armature 132 contacts the end surface 134 of the inlet tube 130. Similarly, the magnetic flux causes a magnetic attraction between the bottom surface 137 of the flux washer 135 and the armature 132 that provides additional axial force to pull the valve 124 upward against the biasing force of the spring 128. When the coil 138 of the solenoid 136 is no longer energized, the force of the spring 128 closes the valve 124.

Preferably, the fuel injector 110 includes a non-magnetic shim 144 positioned between the bottom surface 137 of the flux washer 135 and the armature 132 to prevent the armature 132 from coming into direct contact with the bottom surface 137 of the flux washer 135 and the end surface 134 of the inlet tube 130. The non-magnetic shim will reduce magnetic sticking between the armature 132 and the flux washer 135 and inlet tube 130.

Referring to FIG. 4, in an alternative embodiment, the shield 139 extends down below the end surface 134 of the inlet tube 130 and the bottom surface 137 of the flux washer 135 to prevent the armature 132 from coming into direct contact with the bottom surface 137 of the flux washer 135 and the end surface 134 of the inlet tube 130.

Similar to the prior art, the end surface 134 of the inlet tube 130 provides an axial magnetic flux to pull the armature 132 upward, however, the bottom surface 137 of the flux washer 135 of the present invention provides a second axial magnetic flux, to roughly double the force pulling the armature upward with same amount of overall flux. This provides a substantially higher ratio of opening force to mass of the armature 132 and valve 124, which translates into quicker valve 124 opening time.

In the preferred embodiment of the present invention, the armature 132 includes two groups of through holes formed therein that are axially aligned. A first group includes through holes 146 which are adapted to allow fuel to flow through the armature 132. A second group includes through holes 148 which are adapted to provide venting to prevent the armature from being held upward adjacent the flux washer 135 and inlet tube 130 by hydraulic suction. Further, the presence of the through holes 146, 148 reduces the mass of the armature 132.

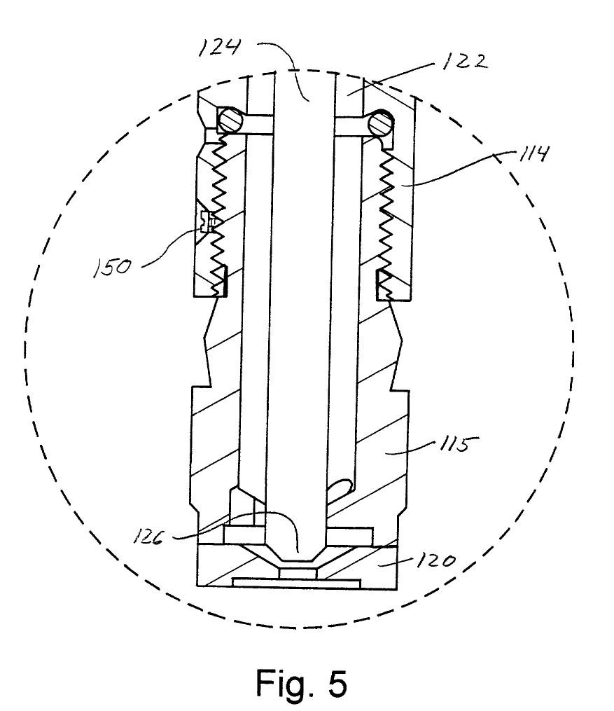

The interface between the armature 132 and both the inlet tube 130 and the flux washer 135 does not easily accommodate stroke setting of the valve 124 and armature 132. Referring to FIG. 5, the tip portion 115 of the valve body 114 is adjustably mounted onto the valve body 114 such that the tip portion 115 is axially adjustable relative to the valve body 114. In the preferred embodiment, the valve body 114 and the tip portion 115 are threadingly engaged, wherein the valve body 114 includes a threaded cavity and the tip portion 115 includes external threads. Rotation of the tip portion 115 will thread the tip portion 115 further into or out of the threaded cavity depending on the direction of rotation, thereby varying the axial position of the seat 120 relative to the valve body 114.

By adjusting the position of the tip portion 115 in this manner, the seat 120 can be positioned relative to the valve body 114 to allow proper engagement of the rounded tip 126 of the valve 124 and the seat 120. Once the seat has been properly positioned, a set-screw 150 secures the tip portion 115 to prevent any rotation of the tip portion 115 within the valve body 114. The tip portion 115 could also be secured within the valve body 114 by other means such as applying Loctite, welding, or staking.

The foregoing discussion discloses and describes the preferred embodiment. One skilled in the art will readily recognize from such discussion, and from the accompanying drawings and claims, that changes and modifications can be made to the preferred embodiment without departing from the true spirit and fair scope of the inventive concepts as defined in the following claims. The preferred embodiment has been described in an illustrative manner, and it is to be understood that the terminology which has been used is intended to be in the nature of words of description rather than of limitation.

What is claimed is:

1. A fuel injector assembly comprising:
a valve adapted to selectively move between an open position and a closed position that prevents fuel from flowing through said fuel injector assembly;
an armature fixedly mounted onto said valve;
a solenoid adapted to generate a magnetic flux to provide a force on said armature and move said valve into the open position; and
a flux washer disposed between said solenoid and said armature and adapted to provide a path for said magnetic flux.

2. The fuel injector of claim 1 further including a biasing member adapted to retain said valve in the closed position.

3. The fuel injector of claim 1 wherein said armature and said flux washer overlap radially and are spaced axially apart from one another such that said flux path travels axially from said flux washer to said armature to provide an axial magnetic attraction between said armature and said flux washer.

4. The fuel injector of claim 3 further including a non-magnetic shim positioned between said flux washer and said armature, said shim adapted to prevent said armature from coming into contact with said flux washer and said inlet tube.

5. The fuel injector of claim 3 further including a non-magnetic shield positioned radially between said inlet tube and said flux washer, wherein said non-magnetic shield extends axially below said flux washer and said inlet tube to prevent said armature from coming into contact with said flux washer and said inlet tube.

6. The fuel injector of claim 1 further including an inlet tube and an outer casing, said solenoid being mounted around said inlet tube and said outer casing extending around said fuel injector such that said magnetic flux travels through said outer casing, radially across said flux washer, axially into said armature, radially across said armature, axially along said inlet tube, and axially back to said outer casing.

7. The fuel injector of claim 1 wherein said armature includes a first plurality of axially aligned holes adapted to allow fuel to flow therethrough.

8. The fuel injector of claim 7 wherein said armature includes a second plurality of axially aligned holes, radially outward of said first plurality of holes, adapted to prevent hydraulic suction to allow said armature to move freely back and forth axially.

9. The fuel injector of claim 1 wherein said valve body includes a tip portion which includes a seat adapted to engage an end of the valve and a nozzle plate having a plurality of orifice holes therein adapted to allow fuel to flow therethrough, said tip portion being adjustably mounted onto said valve body to allow said tip portion to be axially adjustable relative to said valve.
